(19) United States
(12) Patent Application Publication
(10) Pub. No.: US 2021/0216764 A1
(43) Pub. Date: Jul. 15, 2021

(54) AUTOMATED EQUATION ALIGNMENT THROUGH EXPRESSION SIGNATURE

(71) Applicant: General Electric Company, Schenectady, NY (US)

(72) Inventor: Abha MOITRA, Scotia, NY (US)

(21) Appl. No.: 16/743,286

(22) Filed: Jan. 15, 2020

(51) Int. Cl. G06K 9/00; G06K 9/46; G06K 9/62

(52) U.S. Cl. CPC G06K 9/00463; G06K 9/00456; G06K 2209/01; G06K 9/6221; G06K 9/4633

(57) ABSTRACT

According to some embodiments, a system, method and non-transitory computer-readable medium are provided comprising at least one equation source including two or more equations; a signature module; a memory storing program instructions: and a signature processor, coupled to the memory, and in communication with the signature module and operative to execute program instructions to: receive an input from the at least one equation source; identify at least one text equation from the input and at least one code equation from the input; generate a text expression signature for each identified text equation; generate a code expression signature for each identified code equation; map a first text expression signature to a first code expression signature; and output the mapping to one of a user and another system. Numerous other aspects are provided.

### BACKGROUND

Textual documents may include equations, and there may be a corresponding implementation in computer code of these equations that may provide complementary information. As a non-exhaustive example, a web site may provide text (e.g., “document”) with equations included therein. The website may also include a link to another application that may execute the equations included on the website. The equations may be executed via particular computer code (“code”). When a user wants to use the code for execution of a given equation in another application, the user may have to manually go through the code to determine which code snippet corresponds to the equation in the text. This manual process may be very time consuming and inaccurate, as variable names, and even the structure of the representation of the equations, in the text as compared to the code may be different.

It would be desirable to provide systems and methods to align text to code, in an automatic and accurate manner.

### SUMMARY

According to some embodiments, a system includes at least one equation source including two or more equations; a signature module; a memory storing program instructions: and a signature processor, coupled to the memory, and in communication with the signature module and operative to execute program instructions to: receive an input from the at least one equation source; identify at least one text equation from the input and at least one code equation from the input; generate a text expression signature for each identified text equation; generate a code expression signature for each identified code equation; map a first text expression signature to a first code expression signature; and output the mapping to one of a user and another system.

According to some embodiments, a computer-implemented method includes receiving an input from at least one equation source; identifying at least one text equation from the input and at least one code equation from the input; generating a text expression signature for each identified text equation; generating a code expression signature for each identified code equation; mapping a first text expression signature to at least a first code expression signature; and outputting the mapping to one of a user and another system.

According to some embodiments, a non-transitory computer-readable medium storing instructions that, when executed by a computer processor, cause the computer processor to perform a method including receiving an input from at least one equation source; identifying at least one text equation from the input and at least one code equation from the input; generating a text expression signature for each identified text equation; generating a code expression signature for each identified code equation; mapping a first text expression signature to a first code expression signature; and outputting the mapping to one of a user and another system.

Some technical effects of some embodiments disclosed herein are improved systems and methods to automatically uniquely map equations in a text to the corresponding code snippets in implementable code. One or more embodiments provide for the automatic identification of alignment between multiple sources (e.g., text and code) of domain information to provide a more comprehensive source of domain information. One or more embodiments provide for the aggregation of domain information from different sources, including declarative sources like textual documents and procedural information from code. By automating the alignment process, one or more embodiments may provide for the scaling of alignment to a larger extent than possible with manual alignment, and with minimal cost.

With this and other advantages and features that will become hereinafter apparent, a more complete understanding of the nature of the invention can be obtained by referring to the following detailed description and to the drawings appended hereto.

Other embodiments are associated with systems and/or computer-readable medium storing instructions to perform any of the methods described herein.

### BRIEF DESCRIPTION OF THE DRAWINGS

FIGS. 1A-1C are a non-exhaustive example of a data source.

FIG. 2 is a method according to some embodiments.

FIG. 3 is a non-exhaustive example of a text equation and a code equation according to some embodiments.

FIG. 4 is a non-exhaustive example of a text equation and a code equation according to some embodiments.

FIG. 5 is a block diagram of a system according to some embodiments.

FIG. 6 is a block diagram of an alignment platform according to some embodiments of the present invention.

FIG. 7 is a non-exhaustive example of a mapping table according to one or more embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Textual documents involving equations and the corresponding implementation of those equations in computer code (“code”) may provide complementary information. Non-exhaustive examples of complementary information may be textual description and units in the textual document, as well as the associated comments and detailed calculations in the code. Identifying and bringing together this information from multiple sources (e.g., text and code) may provide for the capture of more detailed domain information, which in turn may be used for a more complete analysis. However, aligning information across different sources is conventionally a manual process. The manual process may be time consuming and inaccurate: as variable names may be different between the sources so that there is not a direct 1:1 link between the two sources; the equation may calculate a ratio and/or the equation may calculate iterative process that is not obviously linked between the two. As a non-exhaustive example, the equation may include the fifth root of an element, which would be written simply in the equation is a fifth root. However, to actually implement taking the fifth root of the element, many lines of code may be used, with different intermediate steps etc. It is also noted, that different parts of a source may refer to the same element in different ways. For example, a Greek symbol for gamma may be used sometimes, and the word “gam” may be used at other locations in the text to mean the same thing, or some equations may be numbered/labeled but others may not be.

To address these concerns, one or more embodiments provide a signature module. The signature module may receive the text and the corresponding code. The information provided by the text may typically be more declarative in structure, while the information provided by the code may typically be more detailed and procedural. The signature module may identify equations in each of the text and code. Then for each identified equation, the signature module may identify different aspects in each respective equation to create an expression signature for each equation. The expression signatures may be compared by the signature module to determine whether there is a match between the multiple sources of the equations. It is noted that even if there is only one equation in each of the two sources, they may not match, which may still provide information.

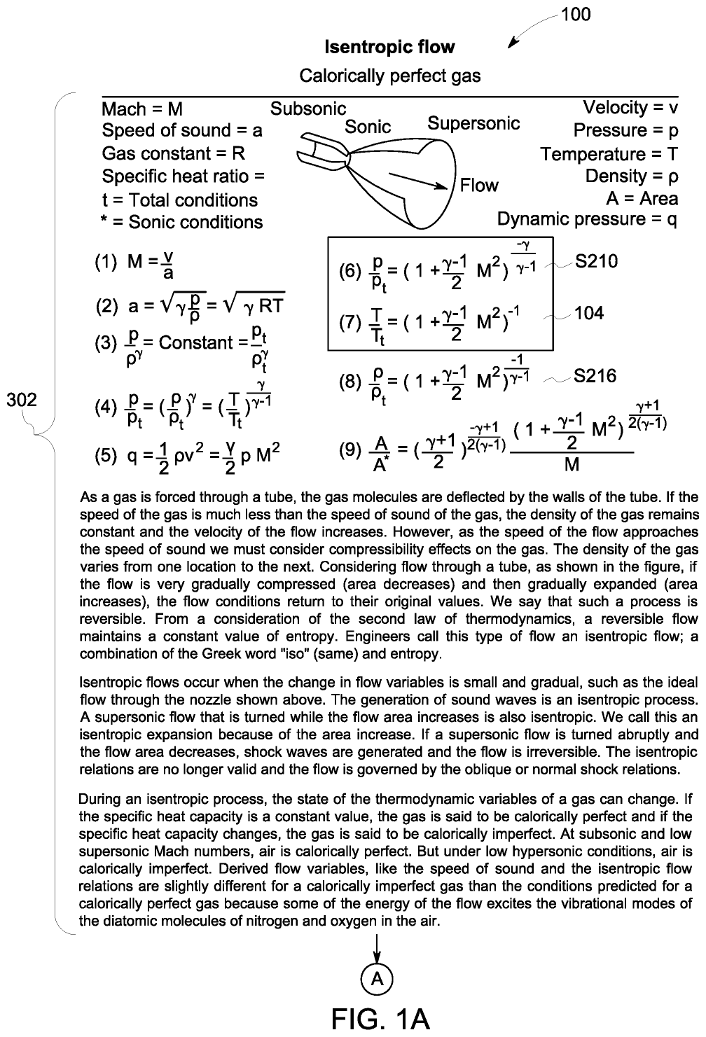

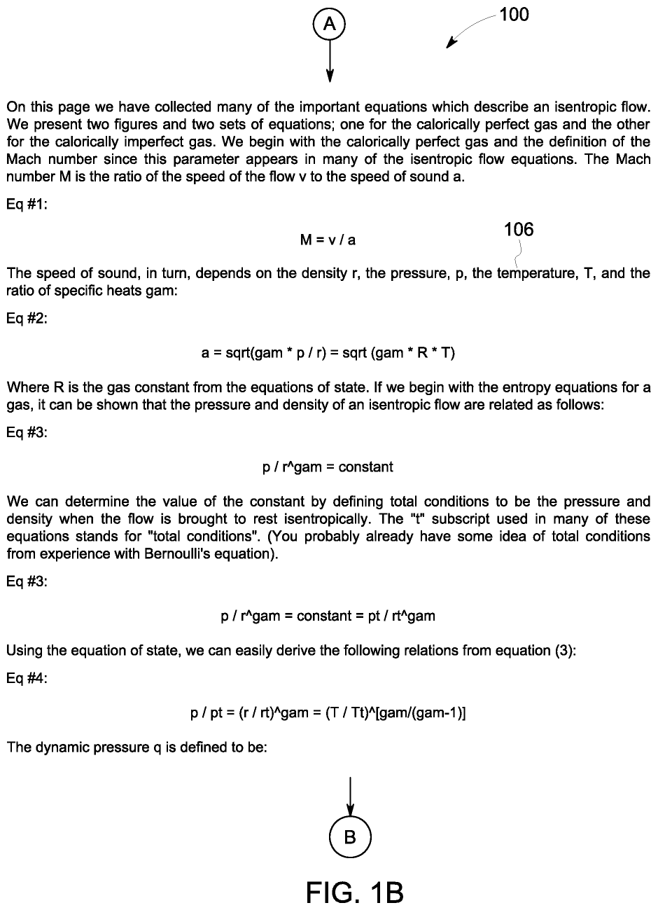

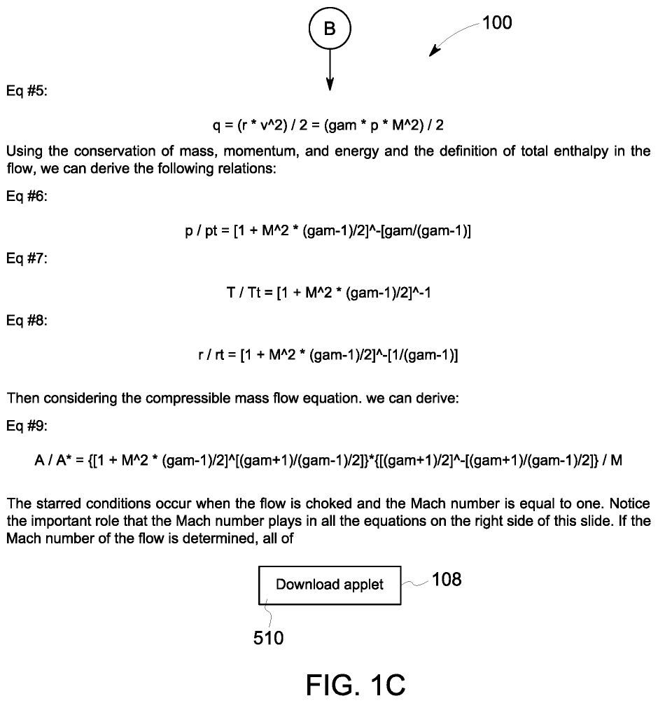

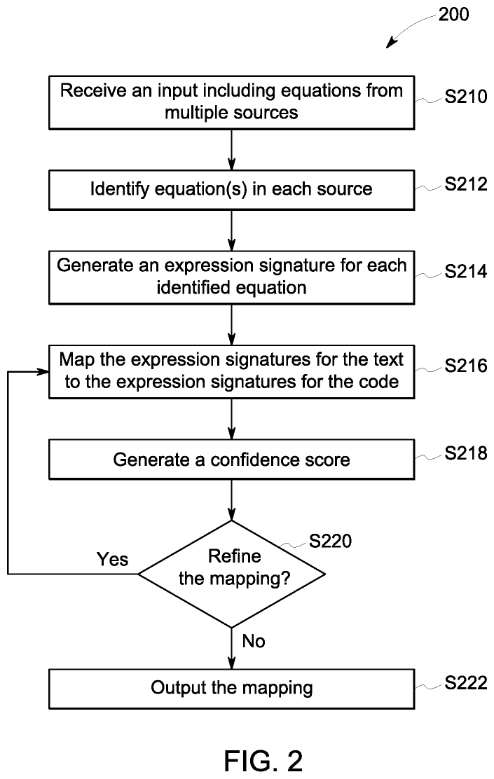

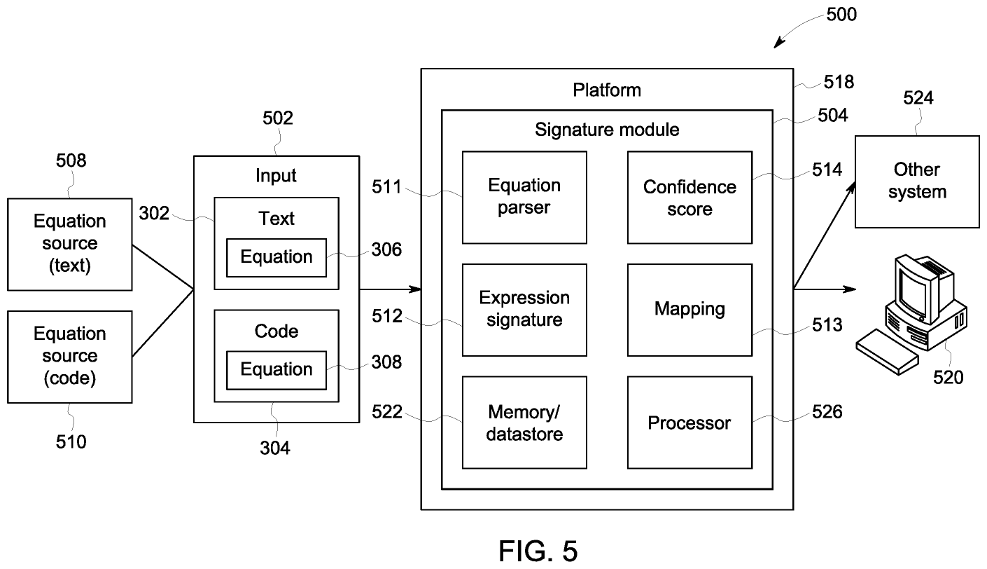

Turning to FIGS. 1-6, a system 500 (FIG. 5) and diagrams of examples of operation according to some embodiments are provided. In particular, FIG. 2 provides a flow diagram of a process 200, according to some embodiments. Process 200, and any other process described herein, may be performed using any suitable combination of hardware (e.g., circuit(s)), software or manual means. For example, a computer-readable storage medium may store thereon instructions that when executed by a machine result in performance according to any of the embodiments described herein. In one or more embodiments, the system 500 is conditioned to perform the process 200 such that the system is a special-purpose element configured to perform operations not performable by a general-purpose computer or device. Software embodying these processes may be stored by any non-transitory tangible medium including a fixed disk, a floppy disk, a CD, a DVD, a Flash drive, or a magnetic tape. Examples of these processes will be described below with respect to embodiments of the system, but embodiments are not limited thereto. The flow charts described herein do not imply a fixed order to the steps, and embodiments of the present invention may be practiced in any order that is practicable.

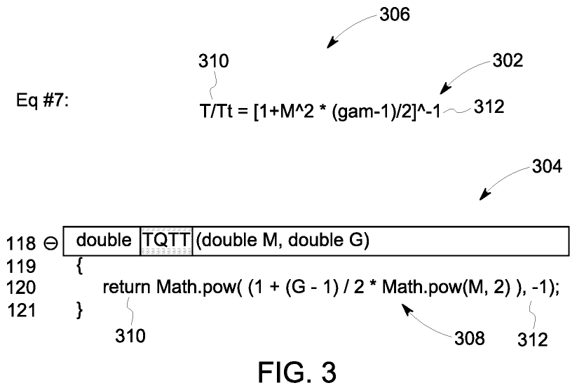

Initially, at S210, an input 502 is received at the signature module 504. In one or more embodiments, a user (now shown) may select the input 502 that is received by the signature module 504. The input 502 may be text 302 (FIG. 3) and code 304 and may be received from one or more input sources (“equation source”) 506. While FIG. 5 shows two different input sources, a text source 508 and a code source 510 it is noted that the text and code may, in one or more embodiments, come from a same source. The text 302 may be in any suitable text format. The text source 508 may be any suitable source, including, but not limited to, a website, textbook, document, etc. The code source 510 may be any suitable source. The code 314 may be in JAVA, HTML, C, C++, python etc. DROP “HTML”, or any other suitable format.

As a non-exhaustive example that will be used throughout the application, FIG. 1 provides a user interface 100 displaying a website 102 for Isentropic Flow from NASA. The website 102 may be a text source 508, and include the text 302 provided on the website, which may include equations. As shown herein, the text may appear as images 104, and as words 106. The website 102 may also include a code source 510, which may be accessed via selection of the “download applet” selector 108. The download applet selector 108 may access the code to execute the equations. While the equations shown on the website 102 are equations to calculate pressure, temperature, speed of objects under certain conditions, etc., any other suitable equations/calculations may be used.

Next, in S212, one or more text equations 306 may be identified in the text 302 and one or more code equations 308 may be identified in the code 304. It is noted that, in one or more embodiments, one of the text 302 and code 304 may have one equation, while the other of the text 302 and the code 304 may have two or more equations. As noted above, in one or more embodiments, there may be only one equation in each of the two sources, and they may not match, which may still provide information. The signature module 504 may use an equation parser 511 to identify a text equation 306 in the text 302 by parsing the text 302 for mathematic symbols (e.g., =, +−, *, /, etc.) or any other suitable symbol. The signature module 504 may first identify the equals sign (“=”) and identify an equation start 310 and an equation end 312 as being on either side of the equals sign. In one or more embodiments, in text, the equation start 310 may be determined as the “word” prior to the equals sign (“=”), and the equation end 312 may be determined based on white space and/or textual paragraph etc. The signature module 504 may identify a code equation 308 in the code 304 also by parsing. With respect to the code, the signature module 504 may be identifying a code snippet as the equation. The code snippet may refer to a small region of re-usable source code, machine code or text. In one or more embodiments, in code, a sub-procedure may correspond to one or more equations. Further, an equation start may be determined as the word prior to the equals symbol (“=”), or by language specific keywords including, but not limited to “return”, etc. An equation end in code may be determined by the end of the sub-procedure or the start of a new equation.

Continuing with the example described above, the signature module 504 identifies equation 7 (306) in the text 302 as: T/Tt=[1+M\hat{ }2*(gam−1)/2]\hat{ }−1. The signature module 504 also identifies the code equation/code snippet 308 as

| [symbol] | |
|---|---|
| 118 [symbol] | double T [symbol] TT(double M, double G) |
| 119 | { |

| | |
|---|---|
| 120 | return Math.pow((1 + (G − 1) / 2 * Math.pow(M, 2)), ~1); |

| | |
|---|---|
| 121 | } |
| [symbol] | |

[symbol]

indicates data missing or illegible when filed

also shown in FIG. 3.

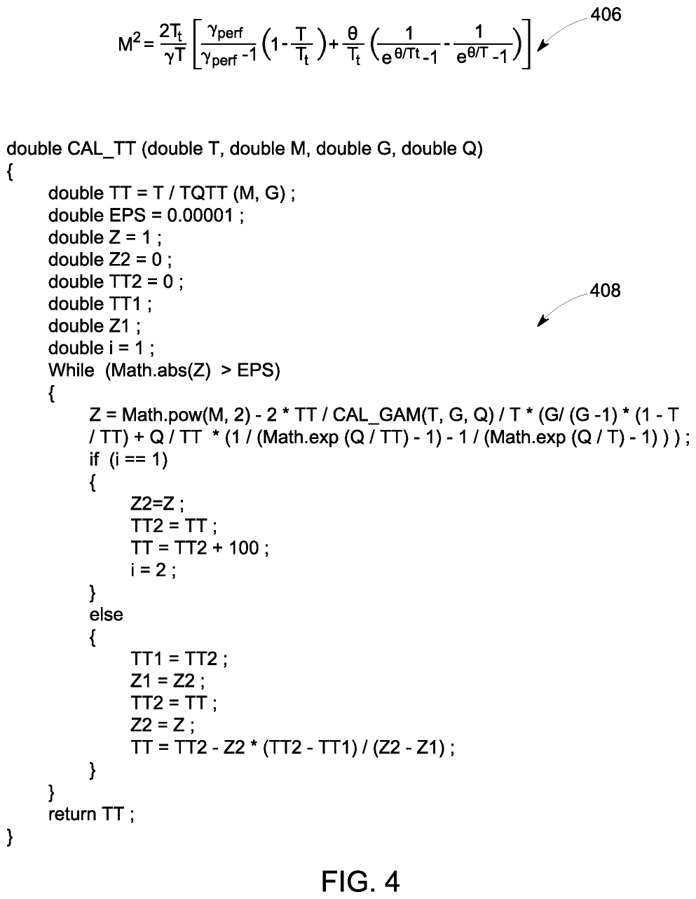

The signature module 504 also identifies the text equation 306 in FIG. 4 and the code equation 308 in FIG. 4.

An Expression Signature 512 is a representation of the expression in the equation. As described above, the signature module 504 may automate the alignment of text equations to code equations. In one or more embodiments, the signature module 504 may do this by modifying the “bag of words” provided by the equations. To that end, in one or more embodiments, an Expression Signature (“ES”) 512 is generated by the signature module 504 in S214.

In one or more embodiments, the right-hand side of an equation is represented as an Expression Signature 512. This process is equally applicable to both text equations and code equations. It is noted that while the following description and examples are with respect to the right-hand side of an equation being the ES 512, the ES may be represented by the left-hand side of the equation. The ES 512 includes an identification of the constants, literals, variables, and method calls in the identified equation, and a count for each. In one or more embodiments, the Expression Signature 512 may be represented as <a1,c1>, <a2,c2>. . . ,<an,cn>, where ai is a constant, literal, variable or method call, and ci is the number of times ai appears in the equation.

Continuing with the example text equation 7 (306) shown in FIG. 3, and starting with the number “1”, in the equation, the ES 512 for that number is <1,3> because the number “1” is represented three times in the equation. Similarly, the ES for the power or exponent is <“power”, 2> because there are two places where an exponent is used. It is noted that the signature module 504 may interpret the terms “power,” “exp”, “exponent” and “A” interchangeably. In one or more embodiments, the signature module 504 may also interchangeably interpret other different sets of words that have a common meaning. For example, in a code equation (308), “power” may be used interchangeably with “Math.pow” and “Math.exp”, which are Java specific notations. It is noted that this “interchangeability” may be specific to the programming language. The signature module 504 generates the entire ES 512 for the text equation in FIG. 3 as:

ES for Eq#7=<1,3>, <2,2><“power”,2>, <“gam”,1>, <“M”,1>

The signature module 504 executes the same process with the code equation 308 in FIG. 3, and generates the ES for the code equation as:

ES of TQTT=<1,3>, <2,2>, <“power”,2>, <“G”,1>, <“M”,1>

In one or more embodiments, the expressional representation in the Equation Signature 512 has been ordered such that constants and literals are in the beginning part of the signature, and the variables are towards the end of the signature. It is noted that the reason for this is that a same ordering of constants and literals may be used for representing an Equation Signature 512 of any expression, whereas variables may be called different things in different equations even though they have the same meaning. For example, in the text equation the variable may be “temp” and in the code equation the same variable is “t”. By ordering the Equation Signature 512 by constants/literals first, when the signature module 504 executes the mapping step, described below, it may speed up the process as if the literals/constants are not identical between equations, there is no reason to consider the variables. On the other hand, if the variables were considered first, the process may take longer as there is not always a 1:1 match between variables, as described above, so the signature module 504 would need to consider the variables, may not be able to determine a match between the variables in the equations and then may analyze the literals/constants. In one or more embodiments the tuples/sequence of variables, as shown herein, are ordered by increasing count and then alphabetically ordered on variable name string. It is noted that such an ordering facilitates visual identification of matches between text equations 306 and code equations 308. Other suitable ordering techniques may be used.

Next, in S216, the ES 512 for the text equation 306 is mapped to the ES 512 for the code equation 308 and a mapping 513 is generated. The signature module 504 may compare any set of one text equation and one code equation via their respective ES 512. As described further below, the mapping may be an iterative process so that an ES for one text equation is compared to an ES for more than one code equation and vice versa. The mapping may first be based on a comparison of the constants and literals. In one or more embodiments, an initial part 314 of the ES 512 may span all the constants and literals. When the signature module 504 determines the initial part 314 for the text equation is identical to the initial part of the ES for the code equation, then a match may exist, otherwise they do not match. After it is determined there is a match of initial parts of the ES for the text equation and the code equation, the ES 512 may be considered good candidates for matching, but may not be a definitive match. As a next part of the mapping determination, a mapping is possible if the counts of the variables are identical, noting that the names of the variables do not have to match. As used herein, the terms “match” and “map” may be used interchangeably.

Continuing with the non-exhaustive example, for the text equation and code equation in FIG. 3:

ES for Eq#7=<1,3>, <2,2><“power”,2>, <“gam”,1>, <“M”,1>

ES of TQTT=<1,3>, <2,2>, <“power”,2>, <“G”,1>, <“M”,1>

the initial part/prefix 314 covering the constants and literals for the text equation 306 is identical to the initial part 314 of the ES covering the constants and literals for the code equation 308, (e.g., <1,3>, <2,2><“power”,2>,” making Eq #7 a good candidate for TQTT. Further, the sorted counts of the variables in the ES for the text equation is identical to the sorted counts of the variables in the ES for the code equation, in that there are two variables in each equation: (gam, M) in the text equation and (G,M) in the code equation, where each variable has a count of “1”. Additionally, a comparison of the ES for the text equation to the ES for the code equation provides variable resolution in that {“gam”, “M”} {“G”, “M”}, although it is not known whether “gam”=“G” and “M”=“M” at this point, as they have the same number of instances in the equations.

It is noted that in one or more embodiments, the Expression Signature 512 may be calculated for expressions that are in “reduced” form. So, if “1+1” is present, it may be replaced by “2”, etc. In one or more embodiments, the signature module may perform this replacement to “normalize” the equation representation.

Following the mapping in S216, a confidence score 514 is generated for the mapping in S218. The confidence score 514 may indicate the level of confidence that the text equation is a match for the code equation based on the mapping of the ES for text equations to the ES for code equations. The confidence score 514 may be based on the number of elements that were matched between the ES for the text equation and the ES for the code equation in the versus the number of possible matchable elements in the ES for the code and text equations. Continuing with the example in FIG. 3, three elements were resolved as there are matches of 1, 2, and power, and other variables are not fully resolved; although the set of {G,M} matches the set of {gam, M} As such, this may have a confidence score 514 of ⅗, where the confidence score is between zero and one, with one being an exact match. Other suitable confidence scoring processes may be used.

Then, in S220 it is determined whether the mapping should be further refined. In one or more embodiments, this determination may be made based on whether the generated confidence score 514 is above a user-defined threshold value. When the confidence score 514 is below the threshold value, it may be determined the mapping should be further refined, and then the process 200 may return to S216 for further refinement of the mapping. It is noted that the mapping refinement may be based on other reasons than the confidence score. As a non-exhaustive example, another pair of equations may match and signify that G matches with gam, and then the process may return to refine the mapping per the earlier example mentioned above. For example, the signature module 504 may compare one ES, of the set used in the mapping of S216 to a different ES that is outside the set used in the mapping of S216. As another example, in one or more embodiments, data from one confidently mapped set of equations (e.g., above the threshold) may provide data usable by the signature module 504 to infer more information about the updated confidence value mapped set of equations. Continuing with the example described herein, these two equations in FIG. 3 could not be entirely resolved because variables in both equations have the same number of occurrence. However, if another set of equations (set B) indicated that “M” from the WS for the text equation equals “M” from the ES for the source equation, then the signature module 504 may infer that “gam” equals “G”. For example, in Set B, “M” may be present in the equations three times, and “M” may be the only element present three times, making M=M. The signature module 504 may use this information to then infer from the equation in FIG. 3, if M=M, then gam=G. In one or more embodiments, the refinement and updating of the confidence score may continue until at least one of a higher confidence score cannot be achieved, the confidence score is above the threshold value, the refinement/updating has exceeded a pre-set number of iterations or pre-set amount of time, or any other suitable endpoint.

When it is determined in S220 that the mapping 513 does not need refinement, the mapping 513 may be output in S222. In one or more embodiments, the mapping 513 may be output to a user via a user interface 520 or to another system 524 for further analysis. In one or more embodiments, the mapping 513 may indicate the connection or link between the text equation 306 and the code equation 308. The mapping 513 may be stored in a mapping table 700 or any other suitable storage. In one or more embodiments, the mapping table 700 may also include notes 702. The “notes” gives the web site and other relevant information. It is noted that the code is available from the web site, so the web site gives both the textual equation and the code snippets.

Turning to FIG. 4, as another non-exhaustive example of a text equation 406 and a code equation 408, the text equation 406 may have an Expression Signature 512 of:

ES=<1,6>, <2,1>, <“gamma”,1>, <“gamma-perf”,2>, <“T”,3>, <“theta”, 3>, <“Tt”,4>,

while the code equation 408 may have an Expression Signature 512 of:

ES=<1,6>, <2,1>, <“CAL GAM(T, G,Q)”,1>, <“G”,2>, <“Q”,3>, <“T”,3>, <“TT”,4>

It is noted that in this case, for readability, the initial part of the equation defining “Z”=Math-pow (M, 2)−2*TT/CAL_GAM(T, G, Q)/T*. So, the above ES is generated for:

$$\text{?} * TT / CAL\_GAM ( T , G , G ) / τ * ( G / ( G - 1 ) * ( \text{?} - T / TT ) * Q / TT * \text{?} / ( Math . exp ( \text{?} / TT ) - 1 ) - 1 / ( Math . exp ( G / T ) - \text{?} \\ \text{?} \text{indicates text missing or illegible when filed}$$

It is further noted that in this snippet, there is a method call to CAL_GAM (T, G, Q), which may be treated as a literal (note that “T” appearing in this does not contribute to the overall count of “T” because it is a call to a sub-procedure, and is treated as being a “literal” and hence indivisible).

Based on the processor, the signature module 504 determines the Expression Signature for the text equation matches the Expression Signature for the code equation, where: “gamma”==“Cal_Gam(T,G,Q)”; “gamma-perf”==“G”; {“T”, “theta”}=={“Q”, “T”} and “Tt”==“TT”. In one or more embodiments, the signature module 512 may treat “1” and “−1” as two different constants, which may provide further discriminating power in the use of the Expression Signature representation. In other embodiments, the signature module 504 may treat “1” and “−1” as the same constant.

With the example shown herein, out of five variables, three were correctly resolved, and two variables were not resolved {“T”, “theta”}=={“Q”, “T”}, although possible matches were reduced correctly.

FIG. 5 is a block diagram of system architecture 500 according to some embodiments. Embodiments are not limited to architecture 500.

Architecture 500 includes a platform 518, a signature module 504, a user platform 520, a data store 522 (e.g., database). In one or more embodiments, the signature module 504 may reside on the platform 518. Platform 518 provides any suitable interfaces through which users/other systems 524 may communicate with the signature module 504.

In one or more embodiments, an output 516 (e.g., mapping 513, mapping confidence score, etc.) of the signature module 504 may be output to a user platform 520 (a control system, a desktop computer, a laptop computer, a personal digital assistant, a tablet, a smartphone, etc.) to view information about the mapped equations. In one or more embodiments, the output 516 from the signature module 504 may be transmitted to various user platforms or to other system (524), as appropriate (e.g., for display to, and manipulation by, a user, further analysis and manipulation).

In one or more embodiments, the system 500 may include one or more processing elements 526 and a memory/computer data store 522. The processor 526 may, for example, be a microprocessor, and may operate to control the overall functioning of the signature module 504. In one or more embodiments, the signature module 504 may include a communication controller for allowing the processor 526 and hence the signature module 504, to engage in communication over data networks with other devices (e.g., user interface 520 and other system 524).

In one or more embodiments, the system 500 may include one or more memory and/or data storage devices 522 that store data that may be used by the module. The data stored in the data store 522 may be received from disparate hardware and software systems, some of which are not inter-operational with one another. The systems may comprise a back-end data environment employed by a business, industrial or personal context.

In one or more embodiments, the data store 522 may comprise any combination of one or more of a hard disk drive, RAM (random access memory), ROM (read only memory), flash memory, etc. The memory/data storage devices 522 may store software that programs the processor 526 and the signature module 504 to perform functionality as described herein.

As used herein, devices, including those associated with the system 500 and any other devices described herein, may exchange information and transfer input and output (“communication”) via any number of different systems. For example, wide area networks (WANs) and/or local area networks (LANs) may enable devices in the system to communicate with each other. In some embodiments, communication may be via the Internet, including a global internetwork formed by logical and physical connections between multiple WANs and/or LANs. Alternately, or additionally, communication may be via one or more telephone networks, cellular networks, a fiber-optic network, a satellite network, an infrared network, a radio frequency network, any other type of network that may be used to transmit information between devices, and/or one or more wired and/or wireless networks such as, but not limited to Bluetooth access points, wireless access points, IP-based networks, or the like. Communication may also be via servers that enable one type of network to interface with another type of network. Moreover, communication between any of the depicted devices may proceed over any one or more currently or hereafter-known transmission protocols, such as Asynchronous Transfer Mode (ATM), Internet Protocol (IP), Hypertext Transfer Protocol (HTTP) and Wireless Application Protocol (WAP).

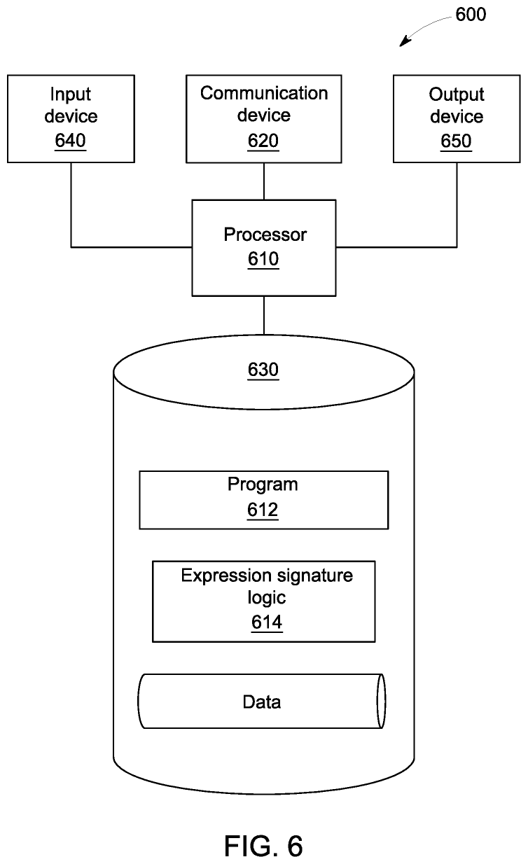

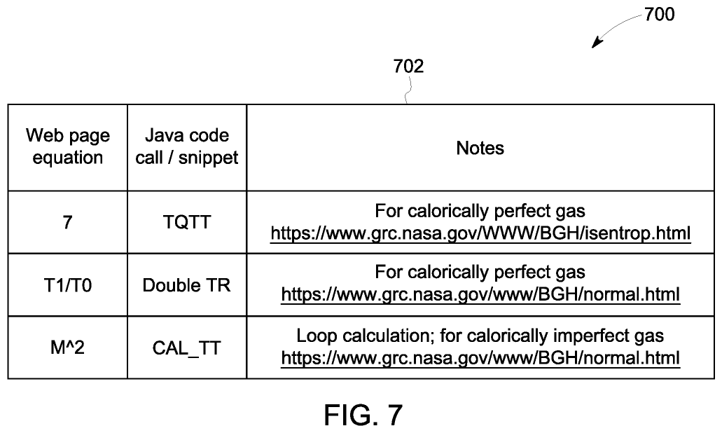

The embodiments described herein may be implemented using any number of different hardware configurations. For example, FIG. 6 is a block diagram of a signature platform 600 that may be, for example, associated with the system 500 of FIG. 5. The signature platform 600 may be implemented using any architecture that is or becomes known, including but not limited to distributed, on-premise, cloud-based and hybrid architectures, as well as embedded in another system. Embodiments are not limited to the signature platform 600. The signature platform 600 may be a database node, a server, a cloud platform, a user device, or the like. The signature platform 600 comprises a processor 610, such as one or more processing devices each including one or more processing cores, and/or one or more commercially available Central Processing Units (“CPUs”) in the form of one-chip microprocessors, coupled to a communication device 620 configured to communicate via a communication network (not shown in FIG. 6). In some examples the processor is a multicore processor or a plurality of multicore processors. The processor may be fixed or reconfigurable. The communication device 620 may be used to communicate, for example, with one or more imagery sources, user platforms, other systems etc. The signature platform 600 further includes an input device 640 (e.g., a computer mouse and/or keyboard, other pointing device, keypad, a microphone, a knob or a switch, an infra-red (IR) port, a docking station, and/or a touch screen to input information) and/an output device 650 (e.g., a speaker, printer, and/or computer monitor to render a display, provide alerts, transmit recommendations, and/or create reports). The input/output devices may include an interface, a port, a cable, a bus, a board, a wire and the like. For example, data may be output to an embedded display of the signature platform 600, an externally connected display, a display connected to the cloud, another device, and the like. According to some embodiments, a mobile device, monitoring physical system, and/or PC may be used to exchange information with the signature platform 600.

The processor 610 also communicates with a storage device 630. The storage device 630 may comprise any appropriate information storage device, including combinations of magnetic storage devices (e.g., a hard disk drive), optical storage devices, mobile telephones, and/or semiconductor memory devices. The storage device 630 may or may not be included within a database system, a cloud environment, a web server, or the like. The storage device 630 stores a program 612 and/or signature processing logic 614 for controlling the processor 610. The processor 610 performs instructions of the programs 612, 614, and thereby operates in accordance with any of the embodiments described herein. For example, the processor 610 may receive, from a plurality of input sources, equations in text and code. The processor 610 may then perform a process to determine whether there is a match between the text equation and the code equation.

The programs 612, 614 may be stored in a compressed, uncompiled and/or encrypted format. The programs 612, 614 may furthermore include other program elements, such as an operating system, clipboard application, a database management system, and/or device drivers used by the processor 610 to interface with peripheral devices.

As used herein, information may be “received” by or “transmitted” to, for example: (i) the signature platform 600 from another device; or (ii) a software application or module within the signature platform 600 from another software application, module, or any other source.

All systems and processes discussed herein may be embodied in program code stored on one or more non-transitory computer-readable media. Such media may include, for example, a hard disk, a DVD-ROM, a Flash drive, magnetic tape, and solid-state Random Access Memory (RAM) or Read Only Memory (ROM) storage units. Embodiments are therefore not limited to any specific combination of hardware and software.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems). Moreover, note that some embodiments may be associated with a display of information to an operator.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A system comprising:
at least one equation source including two or more equations;
a signature module;
a memory storing program instructions: and
a signature processor, coupled to the memory, and in communication with the signature module and operative to execute program instructions to:
receive an input from the at least one equation source;
identify at least one text equation from the input and at least one code equation from the input;
generate a text expression signature for each identified text equation;
generate a code expression signature for each identified code equation;
map a first text expression signature to a first code expression signature; and
output the mapping to one of a user and another system.

2. The system of claim 1 further comprising program instructions to, prior to the output:
generate a confidence score for the mapping; and
refine the mapping based on the confidence score.

3. The system of claim 1, wherein the generation of the text expression signature for each of the identified at least one text equations includes an identification of the constants, literals, variables, and method calls in the identified equation, and a count for each of the constants, literals, variables, and method calls in the identified equation, and wherein the generation of the code expression signature for each of the identified at least one code equations includes an identification of the constants, literals, variables, and method calls in the identified equation, and a count for each of the constants.

4. The system of claim 3, wherein mapping the at least one text expression signature to the at least one code expression signature further comprises program instructions to:
determine any matches between the identified the constants, literals, variables, and method calls in the text expression signature and the identified constants, literals, variables, and method calls in the code expression signature.

5. The system of claim 4, further comprising, for each matched the constants, literals, variables, and method call, program instructions to:
determine any same counts of the matched constants, literals, variables, and method calls.

6. The system of claim 4, further comprising program instructions to:
match the constants, literals and method calls before the variables.

7. The system of claim 1, wherein identification of each of the text equation and code equation further comprises program instructions to:
identify an equals sign; and
identify an equation start and an equation end.

8. The system of claim 2, wherein the confidence score is a measure of the level of confidence that the text equation is a match for the code equation based on the mapping of the first text expression signature to the first code expression signature.

9. The system of claim 2, wherein the mapping is refined until an endpoint is reached.

10. A method comprising:
receiving an input from at least one equation source;
identifying at least one text equation from the input and at least one code equation from the input;
generating a text expression signature for each identified text equation;
generating a code expression signature for each identified code equation;
mapping a first text expression signature to at least a first code expression signature; and
outputting the mapping to one of a user and another system.

11. The method of claim 10 further comprising, prior to the output:
generating a confidence score for the mapping; and
refining the mapping based on the confidence score.

12. The method of claim 10, wherein generating the text expression signature for the identified at least one text equations, and generating the code expression signature for each of the identified at least one code equations further comprises:
identifying the constants, literals, variables, and method calls in the identified equation; and
identifying a count for each of the constants, literals, variables, and method calls in the identified equation.

13. The method of claim 12, wherein mapping the at least one text expression signature to the at least one code expression signature further comprises:
determining any matches between the identified the constants, literals, variables, and method calls in the text expression signature and the identified constants, literals, variables, and method calls in the code expression signature.

14. The method of claim 13, further comprising, for each matched the constants, literals, variables, and method call:
determining any same counts of the matched constants, literals, variables, and method calls.

15. The method of claim 14, further comprising:
matching the constants, literals and method calls before the variables.

16. The method of claim 11, further comprising:
refining the mapping until an endpoint is reached.

17. The method of claim 10, wherein the confidence score is a measure of the level of confidence that the text equation is a match for the code equation based on the mapping of the first text expression signature to the first code expression signature.

18. A non-transient, computer-readable medium storing instructions to be executed by a processor to perform a method comprising:
receiving an input from at least one equation source;
identifying at least one text equation from the input and at least one code equation from the input;
generating a text expression signature for each identified text equation;
generating a code expression signature for each identified code equation;
mapping a first text expression signature to a first code expression signature; and
outputting the mapping to one of a user and another system.

19. The medium of claim 18, wherein generating the text expression signature for each of the identified at least one text equations and generating the code expression signature for each of the identified at least one code equations further comprises:
identifying the constants, literals, variables, and method calls in the identified equation; and
identifying a count for each of the constants, literals, variables, and method calls in the identified equation.

20. The method of claim 18, wherein mapping the at least one text expression signature to the at least one code expression signature further comprises:
determining any matches between the identified the constants, literals, variables, and method calls in the text expression signature and the identified constants, literals, variables, and method calls in the code expression signature; and
for each matched the constants, literals, variables, and method call, determining any same counts of the matched constants, literals, variables, and method calls.
